(19) United States
(12) Patent Application Publication
(10) Pub. No.: US 2019/0318371 A1
(43) Pub. Date: Oct. 17, 2019

(54) COMPUTING SYSTEMS AND METHODS FOR IMPROVING CONTENT QUALITY FOR INTERNET WEBPAGES

(71) Applicant: Walmart Apollo, LLC, Bentonville, AR (US)

(72) Inventors: Pavan Kumar Oruganti, Bangalore (IN); Maria Kristian Bantay, San Anselmo, CA (US); Archimedes Stuk, New York, NY (US)

(21) Appl. No.: 16/009,074

(22) Filed: Jun. 14, 2018

(30) Foreign Application Priority Data
Apr. 13, 2018 (IN) 201811014161

(51) Int. Cl. G06Q 30/02; G06F 17/30; G06Q 30/06

(52) U.S. Cl. CPC G06Q 30/0203; G06F 17/3089; G06Q 30/0641; G06F 17/30902; G06F 17/30905

(57) ABSTRACT

Computing systems and methods for assessing and improving content quality for internet webpages is provided.

### CROSS-REFERENCE TO RELATED PATENT APPLICATIONS

This application claims priority to Indian Patent Application No. 201811014161, filed on Apr. 13, 2018, the content of which is hereby incorporated by reference in its entirety.

### BACKGROUND

Content on webpages can inform users decisions and selections. For example, users learn about items available for purchase through item internet webpages (also known as product pages). When a large number of these webpages exist for a particular website (domain), it can be difficult to ensure that the content on the webpages is satisfactory for informing user decisions.

### BRIEF DESCRIPTION OF DRAWINGS

To assist those of skill in the art in making and using a computing system and associated methods for assessing and improving content quality for internet webpages, reference is made to the accompanying figures. The accompanying figures, which are incorporated in and constitute a part of this specification, illustrate one or more embodiments and, together with the description, help to explain the present disclosure. Illustrative embodiments are shown by way of example in the accompanying drawings and should not be considered as limiting. In the figures:

FIG. 1 illustrates an exemplary network for a content quality improvement system, according to an exemplary embodiment;

FIG. 2 illustrates a flowchart for determining potential orders for items, according to an exemplary embodiment;

FIG. 3 illustrates a flowchart to determine attribute importance and item order potential and display the attribute importance and the item order potential on a content quality dashboard, according to an exemplary embodiment;

FIG. 4 illustrates content attributes arranged by importance based on content attribute scores, according to an exemplary embodiment;

FIG. 5 illustrates a flowchart of a recommendation process for improving content quality, according to an exemplary embodiment;

FIG. 6 is a block diagram of an example computing device that can be used to perform one or more steps provided by exemplary embodiments;

FIG. 7 is a flowchart for improving content quality for internet webpages, according to an exemplary embodiment;

FIG. 8A and FIG. 8B illustrate content score improvement results at a subcategory level, according to an exemplary embodiment; and

FIG. 9 illustrates testing results showing an increase in content quality resulting in increased orders.

### DETAILED DESCRIPTION

Described in detail herein are computing systems and methods for assessing and improving content quality for internet webpages. Embodiments of the computing system can include a database storing items. Each item can be displayable on a webpage. The database also stores content attributes for each item. The content attributes for an item can be displayable on a webpage associated with the item. The computing system can include a processor configured to retrieve, from the database, the items and the content attributes for the items. The processor can score each content attribute according to a first set of rules. In an exemplary embodiment, the first set of rules includes scoring each content attribute based on a relevance of the content attribute to a market vehicle, as described in detail below.

The processor can select a modeling technique from two or more modeling techniques according to a second set of rules. Pursuant to the second set of rules in an exemplary embodiment, the processor can retrieve a first specified percentage of items from the items stored in the database. The processor runs the two or more modeling techniques on the first specified percentage of items to train each model for predicting webpage traffic and webpage orders as a function of the items and the content attribute scores. The processor can retrieve a second specified percentage of items from the items stored in the database and tests the prediction of webpage traffic and webpage orders for each modeling technique against actual webpage traffic and webpage orders. The processor can select the modeling technique based on a lowest margin of error from the testing results.

The processor can estimate a webpage order potential for each item using the selected modeling technique. The processor can prioritize the items based on the order potential for each item, and can select a specified number of high scoring content attributes associated with a specified number of high priority items. The processor can compare each content attribute score of the specified number of high scoring content attributes against a benchmark score associated with a corresponding content attribute. When a content attribute score for an item is less than a benchmark score, the processor can transmit a recommendation to fix or improve the content attribute for the item.

The systems and methods described herein provide a scoring methodology to assess a current state of a website's content health, identify problem areas in webpages, and prioritize items and content attributes of webpages for content improvement. A prior approach includes visually inspecting content on websites, but this is only a marginally effective solution and is ineffective in assessing the current state of a website's content health and prioritizing items and content attributes for content improvement. In addition, the systems and methods provide recommendations and insights to users (e.g., category manager, content specialists, etc.).

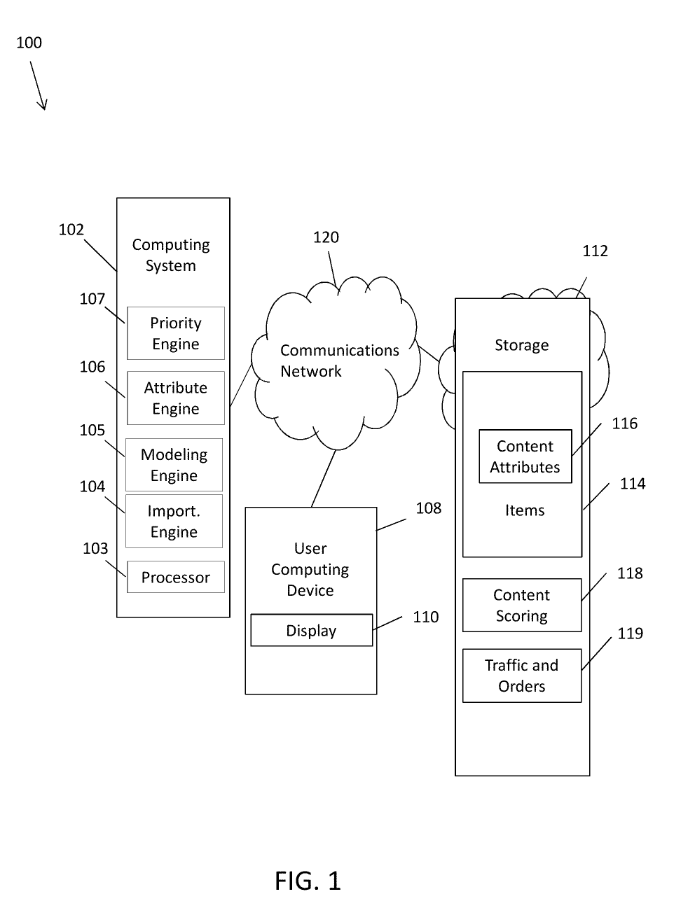

FIG. 1 illustrates an exemplary network for a content quality improvement system 100, according to an exemplary embodiment. The network 100 includes a content quality computing system 102 that includes a processor 103 configured to execute an importance engine 104, a modeling engine 105, an attribute engine 106, and a priority engine 107. It will be appreciated that the importance engine 104, the modeling engine 105, the attribute engine 106, and the priority engine 107 may be provided as a series of executable software and/or firmware instructions. The computing system 102 communicates, via a communications network 120, with one or more user computing devices 108.

The user computing device 108 includes a display 110 for displaying a content quality dashboard, as described herein. The user computing device 108 may be a smartphone, tablet, laptop, workstation or other type of electronic device that includes a processor and is able to communicate with computing system 102. In one embodiment, the computing system 102 may transmit content quality information, via a webpage and/or an application on the user computing device 108, to the display 110.

The computing system 100 further includes a location for data storage 112, such as but not limited to a database. Data storage 112 includes, but is not limited to, storing information regarding items 114 displayable on webpages and content attributes 116 associated with the items 114. Data storage 112 further stores content attribute scoring data 118 used for assigning a score to each content attribute. The content attribute scoring data 118 can be specified for the computing system 100. In one embodiment, the content attribute scores may be observable via the quality dashboard. Data storage 112 may further store webpage traffic and webpage order information 119. Although data storage 112 is shown as remote from computing system 102, in alternative embodiments, data storage 112 can exist within the computing system 102.

The communications network 120 can be any network over which information can be transmitted between devices communicatively coupled to the network. For example, the communication network 120 can be the Internet, an Intranet, virtual private network (VPN), wide area network (WAN), local area network (LAN), and the like.

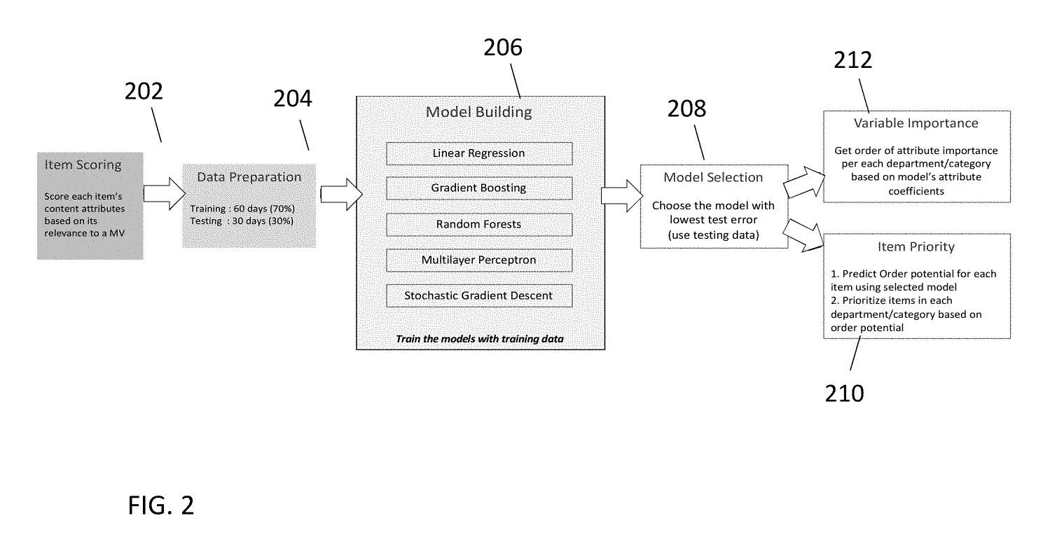

FIG. 2 illustrates a method to determine potential webpage orders for items, according to an exemplary embodiment. In operation 202, an attribute engine (e.g., attribute engine 106 shown in FIG. 1) of a content quality computing system (e.g., content quality computing system 102 shown in FIG. 1) scores content attributes for each item. The attribute engine scores the content attributes for each item based on its relevance to a marketing vehicle. The attribute engine applies a content attribute score to each content attribute for each item within a department or a category based on traffic and a marketing vehicle. A marketing vehicle refers to a specific method or a marketing channel to deliver a message or an advertisement. For example, a marketing vehicle includes, but is not limited to, product description and reviews for search engine optimization (SEO), internal searches and item specific attributes for Organic searches (such as size and material), and data associated with search queries for search engine marketing (SEM).

A content attribute is descriptive information for an item presented on a webpage. Content attributes for an item include, but are not limited to, at least one of an item name, an item description, one or more item images, one or more customer ratings, one or more customer reviews, an item comparison table to similar items, one or more frequently asked questions and answers, one or more interactive tours of the item, one or more item videos, item metadata, one or more item manuals, and item specifications. A webpage for an item typically contains one or more content attributes. Each of these content attributes can be grouped into one or more of three categories: core content, rich content, and metadata. Core content provides basic information regarding an item (e.g., item description, images, ratings & reviews, etc.). Rich content provides ancillary and contextual information used by a customer to make a purchase decision (e.g., comparison tables, unboxing videos, interactive tours, setup manuals, customer Q&A, external marketing links, etc.). Metadata provides item specifications (e.g., item size, color, fit, material, finish, warranty information, etc.).

SEO visits are visits by customers visiting an item webpage through a search engine. SEO orders are orders placed by customers visiting an item webpage through a search engine. Organic visits are visits by customers visiting an item webpage either by searching on the website associated with the webpage (e.g., using a search bar of the website) or by browsing through a directory structure of the website. Organic orders are orders placed by customers visiting an item webpage either by searching on the website associated with the webpage or by browsing through a directory structure of the website. SEM visits are visits by customers that click on search engine ads for an item. SEM orders are orders placed by customers by clicking on search engine ads for an item. A number of SEO orders, Organic orders, and SEM orders are computed by a data computing infrastructure by tagging each order for a marketing vehicle (e.g. SEO, organic, SEM). In the same way, SEO visits, Organic visits, SEM visits are also tagged based on a marketing vehicle used for sourcing each visit. The number of SEO visits and orders, Organic visits and orders, and SEM visits and orders are referred to as search query data and is used to score content attributes, as described herein.

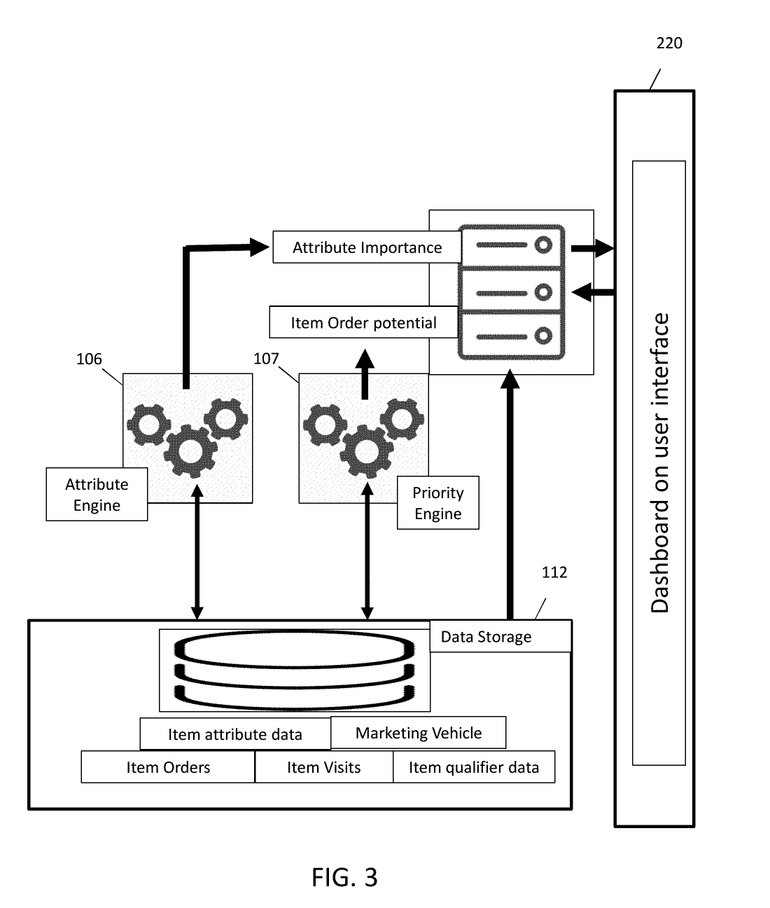

The attribute engine scores each of the content attributes for an item and applies a content attribute score to each item. As a non-limiting example, the attribute engine applies a content attribute score to each content attribute for each item within a department based on traffic and search query data within SEO, Organic, and SEM. For example, as shown in FIG. 3, a long product description 302 has a highest content attribute score within the equipment department. In some embodiments, a priority engine (e.g., priority engine 107 shown in FIG. 1) determines priority and importance among given set of content attributes.

The attribute engine determines content attribute scores by looking at actual values of a content attribute (for example, product description) within a group of similar items and providing a normalized score on a scale of 0 to 1. For a given item, based on a type of the item (e.g., the group of similar items of which the item is a member), there may be one or more expected content attributes. The attribute engine scores the expected attributes as metadata/item description attributes and item webpage attributes, as described below.

With metadata/item description attributes, the attribute engine scores the metadata/item description attributes based on a presence of the attribute. If the attribute has a valid value (e.g., is present), the attribute receives a value of ‘1’. If the attribute is not present, the attribute receives a value of ‘0’. For example, where a t-shirt is a type of item expected to have a brand attribute, the attribute engine determines whether there is a brand attribute associated with the item. If the t-shirt has a brand, then a brand attribute receives a value of ‘1’.

With item webpage attributes, such as product description, images, and reviews, the attribute engine scores the item webpage attributes based on count, such as a number of words in the product description, a number of images, and a number of reviews. An example scenario for illustration purposes involves an scoring methodology with a simple normalization algorithm. For example, in a product type there are 100 items with an average of 100 words per product description. An item with a least number of words in the product description in the product type has 50 words. An item with a most number of words in the product description in the product type has 300 words. In the example scenario, the attribute engine is scoring item X that includes 200 words in the product description. In one embodiment, the attribute engine obtains a normalized score for the product description of item X using the following formula: (200−100)/(300−50)=0.4.

Based on the above procedure using simple normalization or other complex curve fitting algorithms, the attribute engine scores each of the content attributes for each item using a normalized score on a scale of 0 to 1, and applies a content attribute score to each item. Simple normalization as shown above is just one sample algorithm that could be used in scoring.

At operation 204, a modeling engine (e.g., modeling engine 105) prepares for model building. The modeling engine retrieves a first specified percentage (for example, 70%) of the items from database storage (e.g., data storage 112 shown in FIG. 1). The modeling engine then retrieves a second specified percentage (for example, 30%) of items. In an exemplary embodiment, the second specified percentage of items is remaining items not included in the first specified percentage of items (for example, the modeling engine retrieves the remaining 30% of items that were not included in the 70% of items).

At operation 206, the modeling engine begins model building. The modeling engine retrieves the first specified percentage of the items and runs two or more modeling techniques to train each modeling technique for predicting webpage traffic and webpage orders as a function of the items and content attribute scores. In an exemplary embodiment, the training is based on 30 days of historical webpage traffic and historical webpage orders. The two or more modeling techniques include at least two of Linear Regression, Gradient Boosting, Random Forests, Multi-Layer Perceptron, and Stochastic Gradient Descent.

The modeling engine tests each modeling technique's prediction against actual results using the second specified percentage of items. In an exemplary embodiment, the testing is based on webpage traffic and webpage orders for the second specified percentage of items over 30 days. For example, the modeling technique may predict 2 webpage orders for an item and actual results may be 3 webpage orders for the item. In an exemplary embodiment, the modeling occurs separately for each sub-category or category or department.

At operation 208, the modeling engine select a modeling technique from the two or more modeling techniques based on a lowest margin of error from the testing results. For example, the modeling engine may select a best (i.e., lowest error) modeling technique from Linear Regression, Gradient Boosting, Random Forests, Multi-Layer Perceptron, and Stochastic Gradient Descent.

At operation 210, the priority engine estimates potential orders for each item using the selected modeling technique. The priority engine uses an item score and a specified target score. The priority engine determines the item score for each item based on equation 1, shown below.

$$Item Score = \frac{\begin{matrix}SEO {score}^{*} total SEO orders + \\ Organic {score}^{*} total Organic orders + \\ SEM {score}^{*} total SEM orders\end{matrix}}{\begin{matrix}total SEO orders + total Organic orders + \\ total SEM orders\end{matrix}} . \qquad Equation 1$$

where total SEO orders=SEO order potential+actual SEO orders, total organic orders=organic order potential+actual organic orders, and total SEM orders=SEM order potential+actual SEM orders. The target score represents a score of an item that has the best content attributes in a department. In an exemplary embodiment, the target score is 1. The item score represents a weighted content attribute score by actual orders and order potential at the marketing vehicle level. In other words, the item score weighs content quality by order potential. It attempts to capture which subcategory/category/department is giving better returns on investment (ROI) for improving content. The item score evaluates changes of content better than a simple average of a SEO score, an Organic score, and/or a SEM score.

The SEO score, the Organic score, and the SEM Score (also known as marketing vehicle level content quality scores) are computed by weighing content attribute scores by attribute weights. For example, for a SEO profile, if variable importance determines that a product description, a number of images, and a brand are important, then a SEO score=(product description score*product description weight+number of images score*number of images weight+brand score*brand weight)/(product description weight+number of images weight+brand weight). The product description weight, the number of images weight, and the brand weight are obtained from results of an importance engine.

The importance engine models each of attributes with respect to orders, where orders=function (product description score, images score, customer ratings score, size score, brand score, . . . etc.). For example, the function would appear as orders=0.5*product description score+0.25*images score+0.32*customer ratings score+ . . . . The values 0.5 (for product description), 0.25 (for number of images), 0.32 (for customer ratings), etc. are weights. The importance engine determines these weights by using an ensemble approach of several regression techniques (e.g., Linear Regression, Random Forests, Gradient Boosting, Multi-Layer Perceptron, Stochastic Gradient Descent).

Most regression techniques determine weight based on presence. As an illustrative example, in a department with 100 items, 10 items are receiving a lot of orders. If for those 10 items the product description attribute has a good score and the images attribute has a poor score, the importance engine weighs the product description higher and weighs the images lower.

A following example for illustration purposes describes estimating SEO order potential if SEO related content attributes are improved and all else remains the same. The same procedure applies to Organic profiles and SEM profiles. Based on all SEO profile content attributes, an overall SEO score is created. The overall SEO score is a weighted average of the content attribute scores. The overall SEO score can be used as a proxy for the whole SEO profile's content quality. In that case, a model would be, for example, SEO order potential=0.35*gap to benchmark+0.2*top 1M indicator+0.32*two day shipping indicator+0.15*customer sentiment indicator+0.08*in stock indicator. This equation is based on, for example, 100,000 items in the department. To determine the SEO order potential (or estimated future SEO orders for an item if SEO related content attributes are improved and all else remains the same), the priority engine determines SEO orders based on a gap to benchmark (in an exemplary embodiment, the benchmark is 1). For example, in a sample of 5 items in the 100,000 item department, current overall SEO scores are 0.25, 0.3, 0.1, 0.5, and 0.75. Then the gap to benchmark would be 0.75, 0.7, 0.9, 0.5 and 0.25 respectively. In this case SEO order potential is determined as follows:

Potential SEO orders (for item 1)=0.35*(0.75)+0.2*top 1M indicator+0.32*two day shipping indicator+0.15*customer sentiment indicator+0.08*in stock indicator.

Potential SEO orders (for item 2)=0.35*(0.7)+0.2*top 1M indicator+0.32*two day shipping indicator+0.15*customer sentiment indicator+0.08*in stock indicator.

Potential SEO orders (for item 3)=0.35*(0.9)+0.2*top 1M indicator+0.32*two day shipping indicator+0.15*customer sentiment indicator+0.08*in stock indicator.

The items may be prioritized based on current orders and potential orders to prioritize improving content for those items that bring more orders.

The priority engine takes a difference between an item score and a target score for each item. The priority engine then estimates potential visits and potential orders for each item using the selected modeling technique. The priority engine determines potential visits using a function (shown below in equation 2) based on the selected modeling technique that receives content attribute scores (e.g., a product description, customer ratings, images, comparison table, videos, brand, color, size, pattern), and visit and conversion catalysts (e.g., customer sentiment indicator, etc.), and outputs the potential visits.

$$Visits = f \underbrace{( product\_description , customer\_ratings , images ,}_{Core contents attributes} \underbrace{comparison\_table , videos , … ,}_{Rich content attributes} \underbrace{ brand , color , size , material , pattern , …}_{Category specific attributes} . \underbrace{WMT\_MP \_Indicator , Top\_ 1 M\_Indicator , Customer\_Sentiment \_Indicator )}_{Visit Catalysts} . \qquad Equation 2$$

The visit and conversion catalysts are, for example, a MP indicator, a top 1M indicator, a two day shipping indicator, a customer sentiment indicator, and an in stock indicator. The MP indicator shows whether an item is an owned item or if the item is fulfilled by a third party seller. Inherently, owned items are given priority in search results among a group of items to provide better service to customers and an improved experience. The top 1M indicator shows whether the current item is a top million trending item in the market. This is an indicator of how quickly the item would sell. The two day shipping indicator shows whether the item could be shipped to a customer in 2 days. The customer sentiment indicator shows whether the item has positive or negative reviews on a scale of 0 to 1. The in stock indicator shows whether the item is available to be dispatched. The visit and conversion catalysts enable an understanding of the inventory position of items to order to improve content.

The priority engine determines potential orders using a function (shown below in equation 3) based on the selected modeling technique that receives the potential visits determined above, content attribute scores (e.g., a product description, customer ratings, images, comparison table, videos, brand, color, size, pattern), visits catalysts (e.g., customer sentiment indicator, etc.), and conversion catalysts (e.g., in-stock indicator, two day shipping indicator, etc.), and outputs the potential orders.

$$Orders = f ( visits , \underbrace{product\_description , customer\_ratings , images}_{Core contents attributes} , \underbrace{comparison\_table , videos , … ,}_{Rich content attributes} \underbrace{brand , color , size , material , pattern , …}_{Category specific attributes} . \underbrace{WMT\_MP \_Indicator , Top\_ 1 M\_Indicator , Customer\_Sentiment \_Indicator}_{Visit Catalysts} , \underbrace{Two\_Day \_Shipping \_Indicator , In\_Stock \_Indicator )}_{Conversion Catalysts} . \qquad Equation 3$$

The priority engine prioritizes the items based on potential orders.

The potential visits equation and the potential orders equation (equations 2 and 3) determines are how visits and orders are modeled. When training the models, the system obtains item level information—scores of attributes (description, images, size . . . ), number of visits, number of orders, etc. The training is used to establish a relationship between these content attributes.

In an example for illustration purposes, using linear regression, potential visits=0.25*product long description score+0.31*number of images score+0.15*customer ratings score+0.22*brand score+ . . . . Given a set of scores, the system determines how the scores explain the number of visits/number of orders that an item in a department could get.

The priority engine performs opportunity sizing (shown in Equation 4) to determine expected visits or expected orders if a perfect score (i.e., a benchmark score) is reached. For example, an item may have 0.5 as a product long description score, a 0.75 as a number of images score, etc. The potential visits and potential orders determine how many potential visits and/or potential orders if those scores reached the benchmark score.

### Opportunity Sizing

Potential Visits=f(benchmark score−current content scores)

Potential Orders=f(Potential Visits,(benchmark score−current content scores)) Equation 4.

At operation 212, an importance engine (e.g., importance engine 104 shown in FIG. 1) determines an importance of content attributes by product type/sub category/category/department based on an importance of content attribute scores, as show in FIG. 3. The importance scores of the content attributes are the coefficient weight values. For example, where potential orders=0.25*product long description score+0.31*a number images score+0.15*customer ratings score+0.22*brand score+0.09*size score, the importance values are 0.25, 0.31, 0.15, 0.22, and 0.09. The importance engine prioritizes the list of content attributes as (i) the number of images score, (ii) the product long description score, (iii) the brand score, (iv) the customer ratings score, and (v) the size score.

FIG. 3 illustrates a flowchart to determine attribute importance and item order potential and display the attribute importance and the item order potential on a content quality dashboard 220, according to an exemplary embodiment. The content quality dashboard 220 is shown via a user interface on a display (e.g., display 110 shown in FIG. 1) on a user computing device (e.g., user computing device 108).

Data storage 112 stores one or more of item content attributes, marketing vehicle information, item orders, item visits, and item qualifier data. An attribute engine 106 receives data from the storage 112 and determines attribute importance, as described herein. A priority engine 107 receives data from the storage 112 and determines item order potential, as described herein.

The attribute engine 106 transmits the attribute importance to the content quality dashboard 220. The priority engine 107 transmits the item order potential to the content quality dashboard 220. Information stored in storage 112 may also be viewable via the content quality dashboard 220.

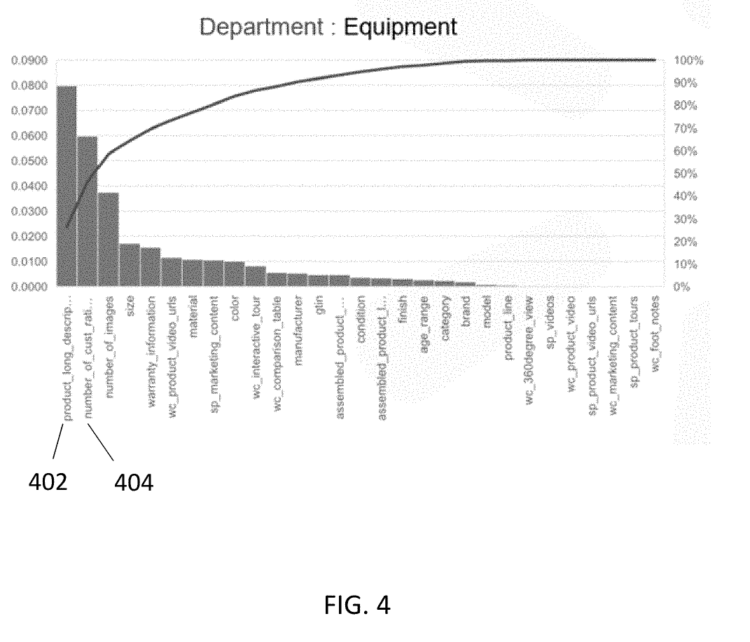

FIG. 4 illustrates content attributes arranged by importance based on content attribute scores, according to an exemplary embodiment. In the example, the content attributes scores are arranged within a department (here, an equipment department) according to a sample SEO impact of each attribute. An attribute engine applies a content attribute score to each content attribute for each item within the department based on traffic and search query data within SEO, Organic, and SEM. This shows relative importance of various content attributes. As shown in the example, a long product description 402 is the most important content attribute within the equipment department.

A higher importance means that content attribute is more important. For example, product long product description 402 has an importance of 0.08 and customer ratings 404 has an importance of 0.06. This means the long product description for the equipment department is 1.4 times more important than the customer ratings. Accordingly, if a cost for improvement or acquisition is the same for both long product description and customer ratings, then obtaining better long product descriptions for the items leads to a greater return on investment than better customer ratings. For example, if the costs to improve the content attributes are the same, FIG. 4 shows an order in which the content attributes should be improved to maximize revenue/orders.

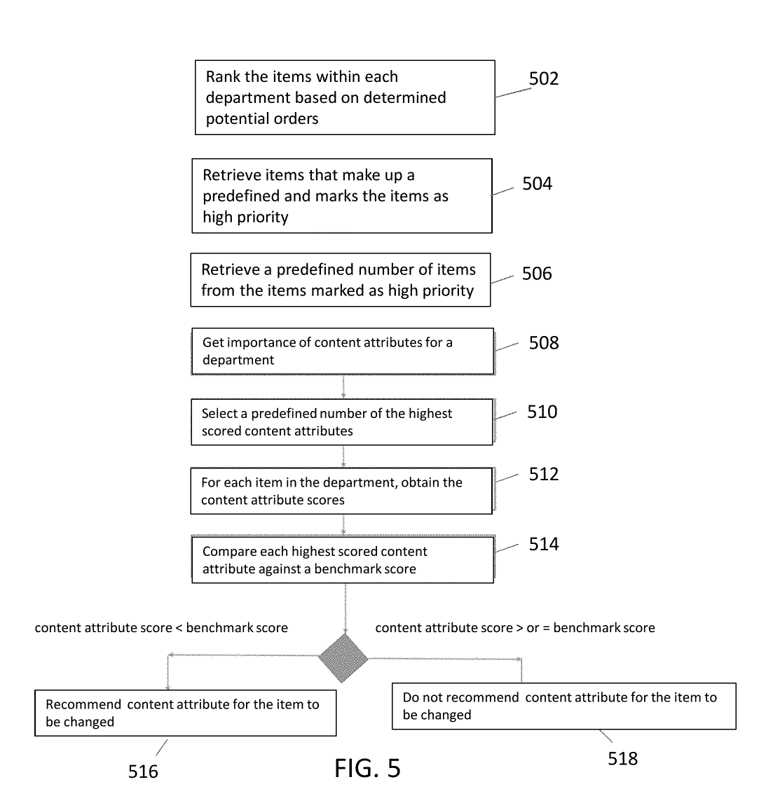

FIG. 5 illustrates a flowchart of a recommendation process for improving content quality, according to an exemplary embodiment. At operation 502, the computing system (e.g., computing system 102 shown in FIG. 1) ranks the items within each department based on potential orders. At operation 504, for each department, the computing system retrieves items of a specified percentile (for example, top 20th percentile) based on order potential, and marks the items as high priority. The high priority items typically contribute to the top 20th percentile of a department's total order potential. At operation 506, for each subcategory within the department, the computing system retrieves a specified number of items (for example, the top 1,000 items) from the high priority items.

At operation 508, the computing system obtains content attributes for a department. The content attributes are arranged by importance based on content attribute scores. At operation 510, the computing system selects a specified number of the highest scored content attributes (for example, the top 30 highest scored content attributes) for the department. The highest scored content attributes provide the biggest return on investment (ROI) when improved. At operation 512, the computing system obtains content attribute scores for the specified number of the highest scored content attributes for each of the high priority items in the department.

At operation 514, for each high priority item in the department, the computing system compares each highest scored content attribute against a benchmark score associated with the content attribute. For example, a content attribute score for a product description is compared against a benchmark score for a product description for that department.

At operation 516, if the content attribute score is less than the benchmark score, the computing system recommends that the content attribute for the item be changed. At operation 518, if the content attribute score is greater than the benchmark score, the computing system does not recommend that the content attribute for the item be changed.

The recommendation suggests prescriptive insights to users (e.g., category managers, merchants, content specialists, etc.) on specific actions to take to improve orders. For example, the recommendation may be to add 3 images for an item to get total score up ‘0.15’ points and get 2 more orders per month. In another example, the recommendation may be that the product description is too short, and to add 50 more words to product description to get score up by 0.1 points and get 1 more SEO order per month. In another example, the recommendation may be to add an ‘animal type’, ‘quantity,’ and ‘color’ metadata attributes and get 1 more Organic order per month.

Recommendations are generated in two forms, for metadata attributes and for other attributes. For metadata attributes, such as size, color, and brand, if a metadata attribute is deemed important and the computing system recommends improving the metadata attribute, then the recommendation is to “fill in the data.” For other attributes, within each subcategory, items are classified as ‘high performers’—items that contribute to the top 80% of sales within the subcategory, ‘underperformers’—items that contribute to the bottom 20% of the sales, and ‘no sales’—items that did not record any sales. The high performer items are considered as benchmarks. The recommendations for the underperformers and the no sales are based on a specified percentile of the high performer value.

In an example for illustration purposes, the specified percentile is 75 percentile of the high performer value. If an item has 2 customer reviews and high performers in the subcategory have 40 customer reviews, then the recommended customer reviews for the item is 0.75*40=30 customer reviews. As a result, the computing system may prompt customers and/or send additional prompts to customers to review the item.

In another example for illustration purposes, the specified percentile is 75 percentile of the high performer value. If an item has 3 images and high performers in the subcategory have 7 images, then the recommended images for the item is 0.75*7=5.25 images. As a result, the computing system may recommend that at least 2 additional images be added to a webpage associated with the item.

To determine the score improvement if the recommendation is implemented, the computing system obtains an established relationship between each of the item attribute scores and the actual values. For example, the computing system obtains a number of words in a product description to the production description score or a number of images vs a number of images score. The relationship are useful in predicting how, for example, an addition of words or an addition of images impact respective scores for attributes.

In an exemplary embodiment, regression models are used to identify an estimated impact of each of the variable on orders by market vehicle (e.g., SEO orders/Organic orders/SEM orders). For example, potential orders=0.25*product long description score+0.31*number of images score+0.15*customer ratings score+0.22*brand score+0.09*size score. When all else is equal, for every 1 point increase in product long description score, potential orders increase by 0.25 per month. Using historical data, an estimated corresponding increase in orders may be determined given an increase in a content quality score. For example, it may be determined that there will be an increase of about 1 order per month after a 10% increase in an Organic score.

The recommendations are displayed via a content quality dashboard displayed on a user computing device (e.g., user computing device 108 shown in FIG. 1). The content quality dashboard may also display item prioritization based on order potential and/or content attribute scores. The dashboard can be used to identify what items and content attributes to focus on for improving conversion and orders (and in the future, track the improvement of scores over time).

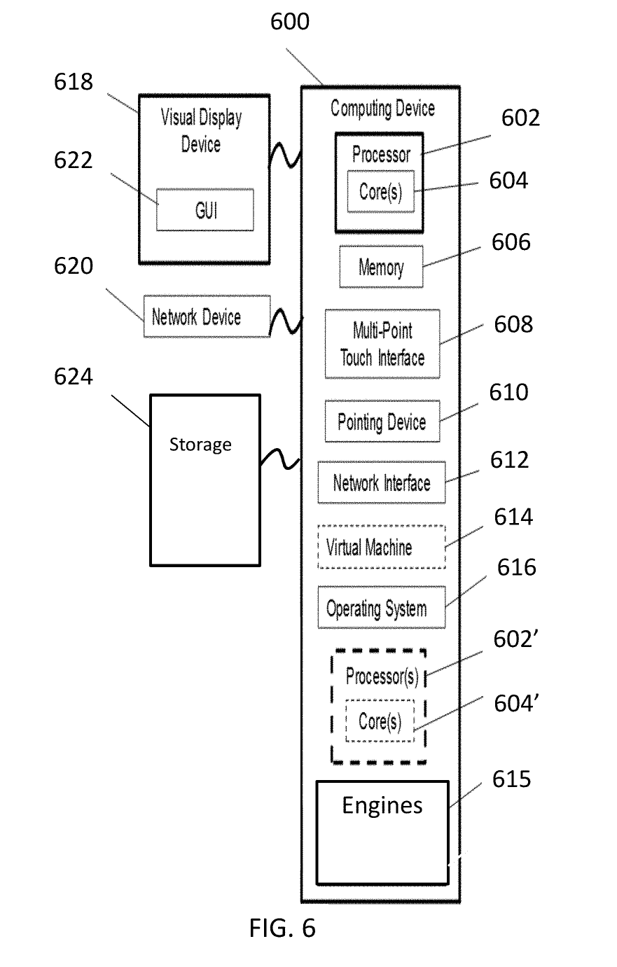

FIG. 6 is a block diagram of an example computing device 600 that can be used to perform one or more steps provided by exemplary embodiments. In an exemplary embodiment, computing device 600 is a computing system 102 shown in FIG. 1 and/or user computing device 108 shown in FIG. 1. Computing device 600 includes one or more non-transitory computer-readable media for storing one or more computer-executable instructions or software for implementing exemplary embodiments such as the prioritization module described herein. The non-transitory computer-readable media can include, but are not limited to, one or more types of hardware memory, non-transitory tangible media (for example, one or more magnetic storage disks, one or more optical disks, one or more USB flash drives), and the like. For example, a memory 606 included in computing device 600 can store computer-readable and computer-executable instructions or software for implementing exemplary embodiments such as the prioritization module described herein. Computing device 600 also includes a processor 602 and an associated core 604, and optionally, one or more additional processor(s) 602′ and associated core(s) 604′ (for example, in the case of computer systems having multiple processors/cores), for executing computer-readable and computer-executable instructions or software stored in memory 606 and other programs for controlling system hardware. Processor 602 and processor(s) 602′ can each be a single core processor or multiple core (604 and 604′) processor. Computing device 600 may further include engines 615, such as an importance engine 104, a modeling engine 105, an attribute engine 106 and a priority engine 107.

Virtualization can be employed in computing device 600 so that infrastructure and resources in the computing device can be shared dynamically. A virtual machine 614 can be provided to handle a process running on multiple processors so that the process appears to be using only one computing resource rather than multiple computing resources. Multiple virtual machines can also be used with one processor.

Memory 606 can include a computer system memory or random access memory, such as DRAM, SRAM, EDO RAM, and the like. Memory 606 can include other types of memory as well, or combinations thereof. In some embodiments, a customer can interact with computing device 600 through a visual display device 618, such as a touch screen display or computer monitor, which can display one or more graphical user interfaces 622 that can be provided in accordance with exemplary embodiments. Visual display device 618 may also display other aspects, elements and/or information or data associated with exemplary embodiments. Computing device 600 may include other I/O devices for receiving input from a customer, for example, a keyboard or any suitable multi-point touch interface 608, and/or a pointing device 610 (e.g., a pen, stylus, mouse, or trackpad). The keyboard 608 and pointing device 610 may be coupled to visual display device 618. Computing device 600 may include other suitable conventional I/O peripherals.

Computing device 600 can also include one or more storage devices 624, such as a hard-drive, CD-ROM, or other computer readable media, for storing data and computer-readable instructions and/or software. Exemplary storage device 624 can also store one or more storage devices for storing any suitable information required to implement exemplary embodiments. In an exemplary embodiment, the storage device 624 stores tasks, specified parameters, and individual attributes.

Computing device 600 can include a network interface 612 configured to interface via one or more network devices 620 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 612 can include a built-in network adapter, network interface card, PCMCIA network card, card bus network adapter, wireless network adapter, USB network adapter, modem or any other device suitable for interfacing computing device 600 to any type of network capable of communication and performing the operations described herein. Moreover, computing device 600 can be any computer system, such as a workstation, desktop computer, server, laptop, handheld computer, tablet computer (e.g., the iPad® tablet computer), mobile computing or communication device (e.g., the iPhone® communication device), or other form of computing or telecommunications device that is capable of communication and that has sufficient processor power and memory capacity to perform the operations described herein.

Computing device 600 can run any operating system 616, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, any operating systems for mobile devices, or any other operating system capable of running on the device and performing the operations described herein. In exemplary embodiments, the operating system 616 can be run in native mode or emulated mode. In an exemplary embodiment, the operating system 616 can be run on one or more cloud machine instances.

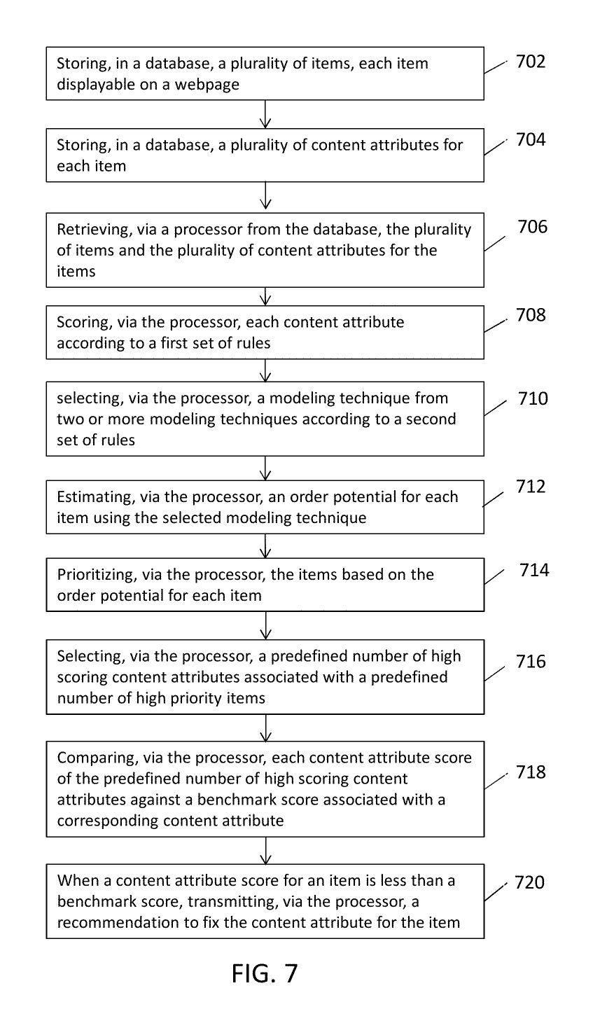

FIG. 7 is a flowchart for improving content quality for internet webpages, according to an exemplary embodiment. At operation 702, a plurality of items are stored in a database. Each item is displayable on a webpage. At operation 704, a plurality of content attributes for each item are stored in a database. At operation 706, a processor retrieves from the database the plurality of items and the plurality of content attributes for the items. At operation 708, the processor scores each content attribute according to a first set of rules. At operation 710, the processor selects a modeling technique from two or more modeling techniques according to a second set of rules. At operation 712, the processor estimates an order potential for each item using the selected modeling technique. At operation 714, the processor prioritizes the items based on the order potential for each item. At operation 716, the processor selects a specified number of high scoring content attributes associated with a specified number of high priority items. At operation 718, the processor compares each content attribute score of the specified number of high scoring content attributes against a benchmark score associated with a corresponding content attribute. At operation 720, when a content attribute score for an item is less than a benchmark score, the processor transmits a recommendation to fix or improve the content attribute for the item.

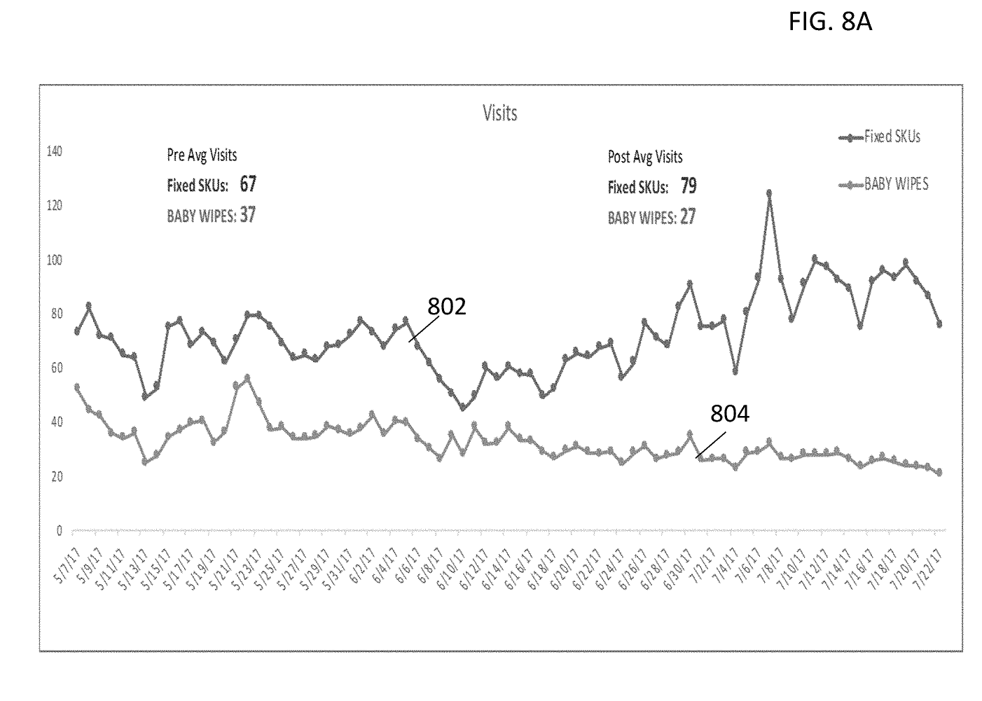

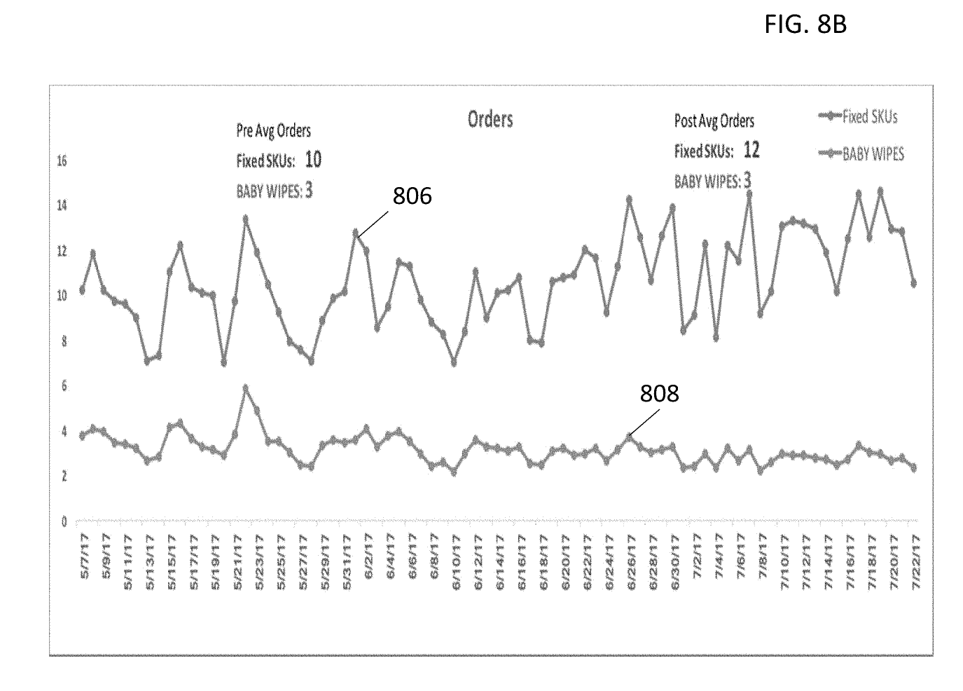

FIG. 8A and FIG. 8B illustrate content score improvement results at a subcategory level, according to an exemplary embodiment. In the illustration, the content is associated with certain items in ‘baby wipes’ subcategory. The graph in FIG. 8A shows how visits changed with items that received content improvements or fixes in ‘baby wipes’. The line graph 802 are items from the ‘baby wipes’ subcategory that received content improvements. The line graph 804 are items from the rest of the ‘baby wipes’ subcategory. For items that received content improvements, item visits increased from 67 visits to 79 on average post content improvements. The rest of the subcategory saw item visits drop from 37 to 27 during the same period.

The graph in FIG. 8B shows how orders change over a period of time before and after content improvements or fixes were performed. The line graph 806 are items from the ‘baby wipes’ subcategory that received content improvements. The line graph 808 are items from the rest of the ‘baby wipes’ subcategory. Items that received content improvements improved from 10 orders to 12 orders on average. During the same time the rest of the items in ‘baby wipes’ subcategory saw orders stay flat at 3 orders on average.

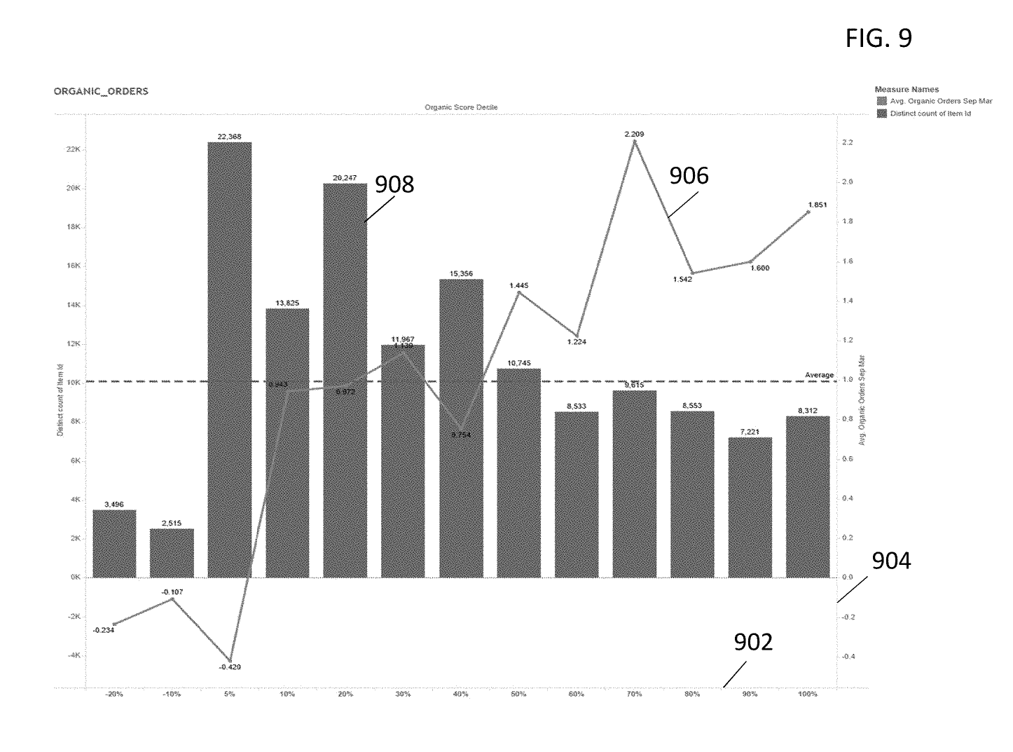

FIG. 9 illustrates testing results showing an increase in content quality (measured by content score) resulting in increased orders. The x axis 902 is a percentage increase in content score over a period of time. The y axis 904 is an average increase in orders over a period of time. The line graph 906 tracks increase in orders for each % change in score (x axis). The bar graph 908 is the affected items.

For example, the graph illustrates that for a 50% increase in a content score of an item, orders increases by 1.45 on average. In this experiment, approximately 10,745 items fall into this category, which saw a 50% bump in content quality score.

The description herein is presented to enable any person skilled in the art to create and use a computer system configuration and related method and systems for expending content quality for internet webpages. Various modifications to the example embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention may be practiced without the use of these specific details. In other instances, well-known structures and processes are shown in block diagram form in order not to obscure the description of the invention with unnecessary detail. Thus, the present disclosure is not intended to be limited to the embodiments shown, but is to be accorded the widest scope consistent with the principles and features disclosed herein.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps can be replaced with a single element, component or step. Likewise, a single element, component or step can be replaced with a plurality of elements, components or steps that serve the same purpose. Moreover, while exemplary embodiments have been shown and described with references to particular embodiments thereof, those of ordinary skill in the art will understand that various substitutions and alterations in form and detail can be made therein without departing from the scope of the invention. Further still, other aspects, functions and advantages are also within the scope of the invention.

Exemplary flowcharts are provided herein for illustrative purposes and are non-limiting examples of methods. One of ordinary skill in the art will recognize that exemplary methods can include more or fewer steps than those illustrated in the exemplary flowcharts, and that the steps in the exemplary flowcharts can be performed in a different order than the order shown in the illustrative flowcharts.

We claim:

1. A system for improving content quality for internet webpages, the system comprising:
a database storing:
a plurality of items, each item displayable on a webpage; and
a plurality of content attributes for each item;
a processor configured to:
retrieve, from the database, the plurality of items and the plurality of content attributes for the items;
score each content attribute according to a first set of rules;
select a modeling technique from two or more modeling techniques according to a second set of rules;
estimate an order potential for each item using the selected modeling technique;
prioritize the items based on the order potential for each item;
select a specified number of high scoring content attributes associated with a specified number of high priority items; and
compare each content attribute score of the specified number of high scoring content attributes against a benchmark score associated with a corresponding content attribute,
wherein when a content attribute score for an item is less than a benchmark score, transmit a recommendation to fix the content attribute for the item.

2. The system of claim 1, wherein the first set of rules comprises the processor further configured to score each content attribute based on a relevance of the content attribute to a market vehicle.

3. The system of claim 1, wherein the second set of rules comprises the processor further configured to:
retrieve a first specified percentage of items from the plurality of items and running the two or more modeling techniques on the specified percentage of items to train each model for predicting webpage traffic and webpage orders as a function of the items and the content attribute scores;
retrieve a second specified percentage of items from the plurality of items and testing the prediction of webpage traffic and webpage orders for each model against actual webpage traffic and webpage orders; and
select the modeling technique based on a lowest margin of error from the testing results.

4. The system of claim 1, wherein the plurality of items are within a department.

5. The system of claim 1, where the content attributes include at least one of a product description, one or more product images, one or more customer ratings, one or more customer reviews, a product comparison table to similar products, frequently asked questions and answers, an interactive tour of product, one or more product videos, and product specifications.

6. The system of claim 1, further comprising an importance engine configured to determine an importance of each content attribute by department based on an importance of the content attribute scores.

7. The system of claim 1, further comprising a content quality dashboard configured to display the recommendation to fix the content attribute for the item.

8. A method for improving content quality for internet webpages, the method comprising:
storing, in a database, a plurality of items, each item displayable on a webpage;
storing, in a database, a plurality of content attributes for each item;
retrieving, via a processor from the database, the plurality of items and the plurality of content attributes for the items;
scoring, via the processor, each content attribute according to a first set of rules;
selecting, via the processor, a modeling technique from two or more modeling techniques according to a second set of rules;
estimating, via the processor, an order potential for each item using the selected modeling technique;
prioritizing, via the processor, the items based on the order potential for each item;
selecting, via the processor, a specified number of high scoring content attributes associated with a specified number of high priority items; and
comparing, via the processor, each content attribute score of the specified number of high scoring content attributes against a benchmark score associated with a corresponding content attribute,
wherein when a content attribute score for an item is less than a benchmark score, transmitting, via the processor, a recommendation to fix the content attribute for the item.

9. The method of claim 8, wherein the first set of rules comprises scoring, via the processor, each content attribute based on a relevance of the content attribute to a market vehicle.

10. The method of claim 8, wherein the second set of rules comprises:
retrieving, via the processor, a first specified percentage of items from the plurality of items and running the two or more modeling techniques on the specified percentage of items to train each model for predicting webpage traffic and webpage orders as a function of the items and the content attribute scores;
retrieving, via the processor, a second specified percentage of items from the plurality of items and testing the prediction of webpage traffic and webpage orders for each model against actual webpage traffic and webpage orders; and
selecting, via the processor, the modeling technique based on a lowest margin of error from the testing results.

11. The method of claim 8, wherein the plurality of items are within a department.

12. The method of claim 8, where the content attributes include at least one of a product description, one or more product images, one or more customer ratings, one or more customer reviews, a product comparison table to similar products, frequently asked questions and answers, an interactive tour of product, one or more product videos, and product specifications.

13. The method of claim 8, further comprising determining, via an importance engine, an importance of each content attribute by department based on an importance of the content attribute scores.

14. The method of claim 8, further comprising displaying, via a content quality dashboard, the recommendation to fix the content attribute for the item.

15. A non-transitory computer-readable medium storing instructions for improving content quality for internet webpages, the instruction when executed by a processing device cause the processing device to:
retrieve, from a database storing a plurality of items and a plurality of content attributes for each item, the plurality of items and the plurality of content attributes for the items;
score each content attribute according to a first set of rules;
select a modeling technique from two or more modeling techniques according to a second set of rules;
estimate an order potential for each item using the selected modeling technique;
prioritize the items based on the order potential for each item;
select a specified number of high scoring content attributes associated with a specified number of high priority items; and
compare each content attribute score of the specified number of high scoring content attributes against a benchmark score associated with a corresponding content attribute,
wherein when a content attribute score for an item is less than a benchmark score, transmit a recommendation to fix the content attribute for the item.

16. The non-transitory computer-readable medium of claim 15, wherein the first set of rules comprises scoring, via the processor, each content attribute based on a relevance of the content attribute to a market vehicle.

17. The non-transitory computer-readable medium of claim 15, wherein the second set of rules comprises:
retrieving, via the processor, a first specified percentage of items from the plurality of items and running the two or more modeling techniques on the specified percentage of items to train each model for predicting webpage traffic and webpage orders as a function of the items and the content attribute scores;
retrieving, via the processor, a second specified percentage of items from the plurality of items and testing the prediction of webpage traffic and webpage orders for each model against actual webpage traffic and webpage orders; and
selecting, via the processor, the modeling technique based on a lowest margin of error from the testing results.

18. The non-transitory computer-readable medium of claim 15, wherein the plurality of items are within a department.

19. The non-transitory computer-readable medium of claim 15, where the content attributes include at least one of a product description, one or more product images, one or more customer ratings, one or more customer reviews, a product comparison table to similar products, frequently asked questions and answers, an interactive tour of product, one or more product videos, and product specifications.

20. The non-transitory computer-readable medium of claim 15, further comprising instructions that when executed by a processing device cause the processing device to determine, via an importance engine, an importance of each content attribute by department based on an importance of the content attribute scores.

21. The non-transitory computer-readable medium of claim 15, further comprising instructions that when executed by a processing device cause the processing device to display, via a content quality dashboard, the recommendation to fix the content attribute for the item.
